(19) United States
(12) Patent Application Publication
(10) Pub. No.: US 2022/0049947 A1
(43) Pub. Date: Feb. 17, 2022

(54) INFORMATION PROCESSING APPARATUS, INFORMATION PROCESSING METHOD, AND RECORDING MEDIUM

(71) Applicant: SONY GROUP CORPORATION, Tokyo (JP)

(72) Inventor: Tomohisa TANAKA, Tokyo (JP)

(73) Assignee: SONY GROUP CORPORATION, Tokyo (JP)

(21) Appl. No.: 17/435,556

(22) PCT Filed: Feb. 13, 2020
(86) PCT No.: PCT/JP2020/005471

§ 371 Date: Sep. 1, 2021

(30) Foreign Application Priority Data
Mar. 26, 2019 (JP) 2019-058265

(51) Int. Cl. G01B 11/02; G06F 3/01

(52) U.S. Cl. CPC G01B 11/026; G01B 11/022; G06F 3/012

(57) ABSTRACT

An information processing apparatus according to the present disclosure includes an acquisition unit that acquires a change in a distance between a real object that is operated by a user in a real space and a virtual object that is superimposed in the real space in the display unit, on the basis of a detection result of a sensor that detects a position of the real object, and an output control unit that displays, on the display unit, a sensory organ object representing a sensory organ of the virtual object for recognizing the real space, and continuously changes a predetermined region of the sensory organ object in accordance with the change in the distance acquired by the acquisition unit.

### FIELD

The present disclosure relates to an information processing apparatus, an information processing method, and a recording medium. In particular, the present disclosure relates to a process of controlling an output signal in accordance with operation performed by a user.

### BACKGROUND

In the augmented reality (AR) technology, a virtual reality (VR) technology, and the like, a technique that makes it possible to operate a device by recognition based on image processing of displaying a virtual object and sensing has been used. Meanwhile, in some cases, the AR technology may be referred to as a mixed reality (MR) technology.

For example, a technology of acquiring depth information on a subject included in a captured image and performing an effect process to make it possible to convey, in an easily understandable manner, information on whether the subject is present in an appropriate range at the time of object composition has been known. Further, a technology that makes it possible to recognize a hand of a user who is wearing a head-mounted display (HMD) with high accuracy has also been known.

### CITATION LIST

### Patent Literature

Patent Literature 1: Japanese Laid-open Patent Publication No. 2013-118468

Patent Literature 2: International Publication No. WO/2017/104272

### SUMMARY

### Technical Problem

In the AR technology, in some cases, a user is requested to perform a certain interaction, such as a touch on a virtual object, which is superimposed on a real space, with hand.

In general, a virtual image distance (focal length) of a display used in the AR technology is limited. For example, the virtual image distance of the display generally tends to be fixed to a certain distance. Therefore, even in a case in which stereoscopic display is performed by changing display positions of images for left and right eyes, the virtual image distance of the display is not changed. Consequently, a conflict may occur between a display mode of the virtual object and human visual characteristics. This problem is generally known as a vergence-accommodation conflict. The vergence-accommodation conflict makes it difficult for a user to appropriately recognize a sense of distance to a virtual object that is displayed at a near distance or a far distance. For example, even if the user attempts to touch the virtual object with hand, in some cases, the user may fail to reach the virtual object or may extend the hand to the far side across the virtual object.

In the present disclosure, an information processing apparatus, an information processing method, and a recording medium capable of improving performance of space recognition of a user in a technology of superimposing a virtual object in a real space.

### Solution to Problem

According to the present disclosure, an information processing apparatus includes an acquisition unit that acquires a change in a distance between a real object that is operated by a user in a real space and a virtual object that is superimposed in the real space on the display unit, on the basis of a detection result of a sensor that detects a position of the real object; and an output control unit that displays, on the display unit, a sensory organ object representing a sensory organ of the virtual object for recognizing the real space, and continuously changes a predetermined region of the sensory organ object in accordance with the change in the distance acquired by the acquisition unit.

### Advantageous Effects of Invention

According to the information processing apparatus, the information processing method, and the recording medium of the present disclosure, it is possible to improve performance of space recognition of a user in a technology of superimposing a virtual object in a real space. Meanwhile, the effect described herein is not limitative, and any of effects described in the present disclosure may be achieved.

### BRIEF DESCRIPTION OF DRAWINGS

FIG. 1 is a first diagram illustrating an overview of information processing according to a first embodiment of the present disclosure.

FIG. 2 is a second diagram illustrating the overview of the information processing according to the first embodiment of the present disclosure.

FIG. 3 is a third diagram illustrating the overview of the information processing according to the first embodiment of the present disclosure.

FIG. 4 is a fourth diagram illustrating the overview of the information processing according to the first embodiment of the present disclosure.

FIG. 5 is a fifth diagram illustrating the overview of the information processing according to the first embodiment of the present disclosure.

FIG. 6 is a sixth diagram illustrating the overview of the information processing according to the first embodiment of the present disclosure.

FIG. 7 is a diagram for explaining an output control process according to the first embodiment of the present disclosure.

FIG. 8 is a diagram illustrating an external appearance of an information processing apparatus according to the first embodiment of the present disclosure.

FIG. 9 is a diagram illustrating a configuration example of the information processing apparatus according to the first embodiment of the present disclosure.

FIG. 10 is a first diagram for explaining the information processing according to the first embodiment of the present disclosure.

FIG. 11 is a second diagram for explaining the information processing according to the first embodiment of the present disclosure.

FIG. 12 is a third diagram for explaining the information processing according to the first embodiment of the present disclosure.

FIG. 13 is a flowchart illustrating the flow of a process according to the first embodiment of the present disclosure.

FIG. 14 is a first diagram for explaining information processing according to a second embodiment of the present disclosure.

FIG. 15 is a second diagram for explaining the information processing according to the second embodiment of the present disclosure.

FIG. 16 is a diagram illustrating a configuration example of an information processing system according to a third embodiment of the present disclosure.

FIG. 17 is a diagram for explaining information processing according to the third embodiment of the present disclosure.

FIG. 18 is a hardware configuration diagram illustrating an example of a computer that implements functions of the information processing apparatus.

### DESCRIPTION OF EMBODIMENTS

Embodiments of the present disclosure will be described in detail below based on the drawings. Meanwhile, in each of the embodiments below, the same components are denoted by the same reference symbols, and repeated explanation thereof will be omitted.

### 1. First Embodiment

1-1. Overview of Information Processing According to First Embodiment

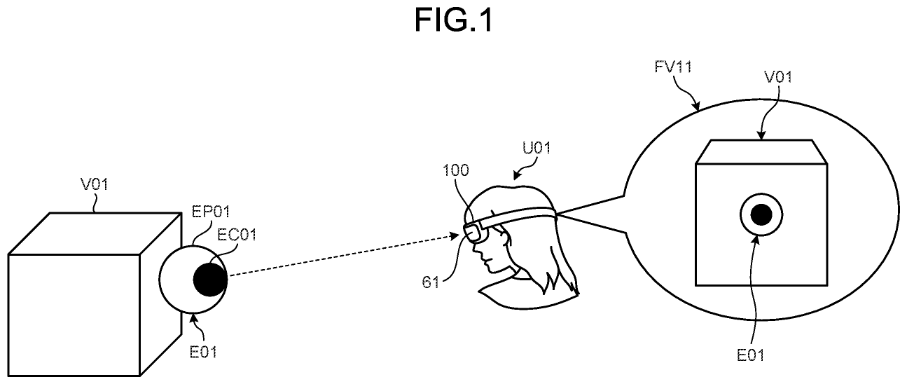

FIG. 1 is a first diagram illustrating an overview of information processing according to a first embodiment of the present disclosure. The information processing according to the first embodiment of the present disclosure is performed by an information processing apparatus 100 illustrated in FIG. 1.

The information processing apparatus 100 is an information processing terminal for implementing what is called the AR technology or the like. In the first embodiment, the information processing apparatus 100 is a wearable device that is used by being worn on a head of a user U01. In particular, the information processing apparatus 100 according to the present disclosure may be referred to as an HMD, an AR glass, or the like.

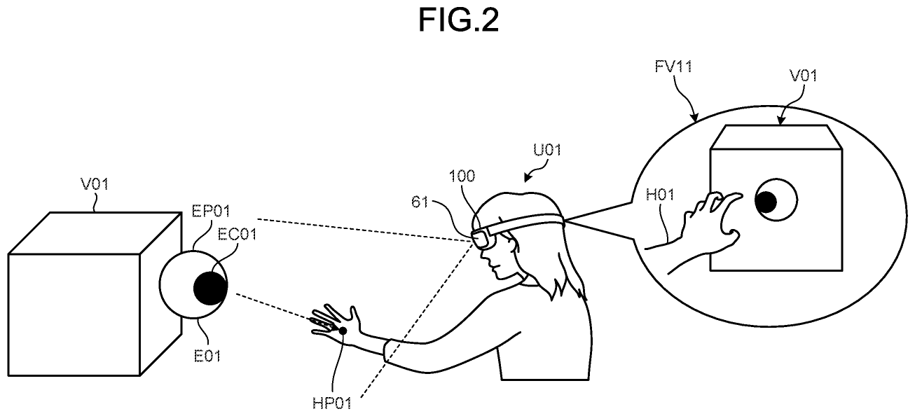

The information processing apparatus 100 includes a display unit 61 that is a transmissive display. For example, the information processing apparatus 100 displays a superimposed object that is represented by computer graphics (CG) or the like on the display unit 61 by superimposing the superimposed object in the real space. In the example illustrated in FIG. 1, the information processing apparatus 100 displays a virtual object V01 as the superimposed object. Meanwhile, in FIG. 1 and other drawings, display FV11 represents information that is displayed on the display unit 61 (in other words, information that is viewed by the user U01). The user U01 is able to simultaneously view a real object in addition to the display FV11 via the display unit 61 as illustrated in FIG. 2. The information processing apparatus 100 may include a configuration for outputting a predetermined output signal, in addition to the display unit 61. For example, the information processing apparatus 100 may include a speaker or the like for outputting voice.

The virtual object V01 is arranged with reference to the global coordinate system that is associated with the real space, on the basis of a detection result of a sensor 20 (to be described later). For example, in the global coordinate system, when the virtual object V01 is fixed at a first coordinate (x1, y1, z1), and even if the user U01 (the information processing apparatus 100) moves from a second coordinate (x2, y2, z2) to a third coordinate (x3, y3, z3), the information processing apparatus 100 changes at least one of a position, a posture, and a size of the virtual object V01 on the display unit 61 such that the user recognizes that the virtual object V01 remains present at the first coordinate (x1, y1, z1).

With the AR technology, the user U01 is able to perform an interaction, such as a touch on the virtual object V01 or taking of the virtual object V01 with hand, by using an arbitrary input means in the real space. The arbitrary input means is an object operated by the user and is an object that can be recognized by the information processing apparatus 100 in the space. For example, the arbitrary input means may be a part of the body, such as a hand or a foot of the user, a controller that is held in the hand of the user, or the like. In the first embodiment, the user U01 uses the hand H01 of the user as the input means (see FIG. 2 and other drawings). In this case, a touch on the virtual object V01 with the hand H01 indicates that, for example, the hand H01 is present in a predetermined coordinate space in which the information processing apparatus 100 recognizes that the user U01 has touched the virtual object V01.

The user U01 is able to view a real space that is viewed through the display unit 61 and the virtual object V01 that is superimposed in the real space. Further, the user U01 performs an interaction of touching the virtual object V01 by using the hand H01.

However, due to display characteristics of a normal display, it is difficult for the user U01 to recognize a sense of distance to the virtual object V01 that is displayed at a near distance (for example, in a range of about 50 cm from a viewpoint). As described above, in general, the virtual image distance of the display is fixed to a constant value. Therefore, for example, when the virtual image distance is fixed to 3 meters (m), and if the virtual object V01 is displayed within several tens of centimeters in which the hand of the user U01 is extendable, a conflict occurs such that the virtual object V01 with the virtual image distance of 3 m is fused at a distance of several tens of centimeters. The conflict as described above is generally known as a vergence-accommodation conflict. Due to the conflict as described above, the user U01 may fail to extend the hand H01 to the virtual object V01 even though the user assumes that the touch is successful or the user may extend the hand H01 to the far side across the virtual object V01. Further, if the interaction with respect to the virtual object V01 is not recognized by the AR device, it is difficult for the user U01 to determine where to move the hand H01 in order that the interaction is recognized, and it is difficult to correct a position.

Meanwhile, a recognition mismatch as described above is more apparent in a display with optical transparency (Optical See-Through Display (OST display). In the example as described above, if the OST display is used, the user needs to simultaneously view ae virtual object (V01) with the virtual image distance of 3 m and the fusion distance of several tens of centimeters, and a real object (the hand H01 in the example illustrated in FIG. 1) with the virtual image distance of several tens of centimeters and the fusion distance of several tens of centimeters. Therefore, if a display with a fixed virtual image distance is used, the user U01 is not able to simultaneously focus on the virtual object V01 and the hand H01 when directly performing an interaction with respect to the virtual object V01 by using the hand H01. Meanwhile, if a video see-through display (VST display) is used, the real object is replaced as a display object, and has the virtual image distance of 3 m that is the same as that of the virtual object. In other words, if the OST display is used, as compared to a case in which the VST display is used, it becomes more difficult for the user U01 to recognize the position of the virtual object V01 in the depth direction.

The information processing apparatus 100 according to the present disclosure performs information processing as described below in order to improve space recognition performance in the AR technology. Specifically, the information processing apparatus 100 acquires a change in a distance between the real object (the hand H01 in the example illustrated in FIG. 1) that is operated by the user U01 in the real space and the virtual object (the virtual object V01 in the example illustrated in FIG. 1) that is displayed on the display unit 61. The change in the distance is determined by an acquisition unit 32 on the basis of a position of a real object that is detected by the sensor 20 (to be described later).

The information processing apparatus 100 further displays a sensory organ object that represents a sensory organ of the virtual object V01. In the example illustrated in FIG. 1, it may be possible to assume that an indicator E01 that represents a human eyeball corresponds to the sensory organ object. The sensory organ object has a predetermined region that is continuously changed in accordance with the change in the distance as described above. In the example illustrated in FIG. 1, it may be possible to assume that a black part of eye EC01 that is a black part in the indicator E01 corresponds to the predetermined region. Meanwhile, in the present disclosure, the predetermined region that is continuously changed in accordance with the change in the distance as described above may be referred to as a second display region, and a region that is displayed externally adjacent to the second display region may be referred to as a first display region. In the example illustrated in FIG. 1, the second display region is a region that is narrower than the first display region, but an area of the predetermined region is not limited to this example.

In general, it is known that a living organism adjusts a focus of eyeballs, in other words, areas of pupils, in accordance with approach of an object. Therefore, the information processing apparatus 100 changes a display mode of the black part of eye EC01 corresponding to a pupil in the indicator E01 and allows the user U01 to recognize approach of the hand H01 of the user U01. Specifically, the indicator E01 reduces the area of the black part of eye EC01 as if the focus is adjusted in accordance with approach of a real object, in order to reproduce a natural behavior of a living organism.

For example, a size and a position of the black part of eye EC01 of the indicator E01 of the user U01 are changed when the user extends the hand H01 to the virtual object V01. Therefore, even if the vergence-accommodation conflict has occurred, the user U01 is able to easily determine whether the position of the virtual object V01 is still located away from the hand H01 or located close to the hand H01 from the change in the area of the black part of eye EC01. In other words, the black part of eye EC01 functions as an indicator that is able to directly and naturally indicate a recognition result of the sensor 20. Therefore, the information processing apparatus 100 according to the present disclosure is able to solve at least a part of the problem with the vergence-accommodation conflict in the AR technology, and improve space recognition performance of the user U01. The flow of an overview of the information processing according to the present disclosure will be described below with reference to FIG. 1 to FIG. 7.

As illustrated in FIG. 1, the information processing apparatus 100 displays the indicator E01 on a surface of the virtual object V01 (more specifically, on space coordinates that are set as the surface of the virtual object V01). The indicator E01 is configured as a combination of the sclera EP01 and the black part of eye EC01, and is displayed such that the black part of eye EC01 is superimposed on the sclera EP01. As illustrated in the display FV11, the user U01 visually recognizes that the indicator E01 is displayed in a superimposed manner on the virtual object V01. In this manner, the information processing apparatus 100 performs a display control process that represents a situation in which the virtual object V01 “is viewing the user U01”. Meanwhile, it is sufficient that the black part of eye EC01 on the sclera EP01 is displayed in association with the virtual object V01. For example, the black part of eye EC01 on the sclera EP01 may be arranged so as to be included in the surface of the virtual object V01, and may constitute a part of the virtual object V01. The indicator according to the present disclosure is not limited to this example, and it may be possible to adopt various display modes.

In the example illustrated in FIG. 1, the information processing apparatus 100 controls the position, the posture, and the size of the virtual object V01 on the display unit 61 such that the virtual object V01 is recognized at a predetermined position in the global coordinate system when viewed from the user U01, on the basis of location information on the information processing apparatus 100 (in other words, location information on the head of the user U01). As one example of a technology used to estimate a self-position of the user U01, a simultaneous localization and mapping (SLAM) technology is known. In contrast, the information processing apparatus 100 recognizes the hand H01 of the user U01 on the basis of, for example, an image recognition technology that is a recognition technology different from a self-location estimation technology as described above. Therefore, in some cases, the information processing apparatus 100 is not able to recognize a position and a posture of the hand H01, although the information processing apparatus 100 is able to recognize a position and a posture of the user U01. In this case, the information processing apparatus 100 causes the black part of eye EC01 to be oriented toward the head of the user U01, and neglect motion of the hand H01 that is not appropriately detected by the sensor 20. In other words, display of the indicator E01 and the black part of eye EC01 is not changed in accordance with motion of the hand H01. This process will be described in detail later. Meanwhile, when the information processing apparatus 100 does not recognize the hand H01, the information processing apparatus 100 may perform a display process such that the indicator E01 is not displayed or the sclera EP01 and the black part of eye EC01 are displayed as concentric circles, without viewing the head of the user U01.

Explanation will be given below with reference to FIG. 2. FIG. 2 is a second diagram illustrating the overview of the information processing according to the first embodiment of the present disclosure. In the example illustrated in FIG. 2, the user U01 performs an interaction of touching the virtual object V01, which is superimposed in the real space, with the hand H01. At this time, the information processing apparatus 100 acquires the position of the hand H01 raised by the user U01 in the space.

While details will be described later, the information processing apparatus 100 recognizes the hand H01 that is present in the real space and that is viewed by the user U01 through the display unit 61, by using a sensor, such as a recognition camera, that covers a line-of-sight direction of the user U01, and acquires the position of the hand H01. Further, the information processing apparatus 100 sets an arbitrary coordinate HP01 used to measure a distance between the hand H01 and the virtual object V01. Furthermore, the information processing apparatus 100 recognizes the real space displayed in the display unit 61 as a coordinate space, and acquires the position of the virtual object V01 superimposed in the real space. Then, the information processing apparatus 100 acquires the distance between the hand H01 of the user and the virtual object V01.

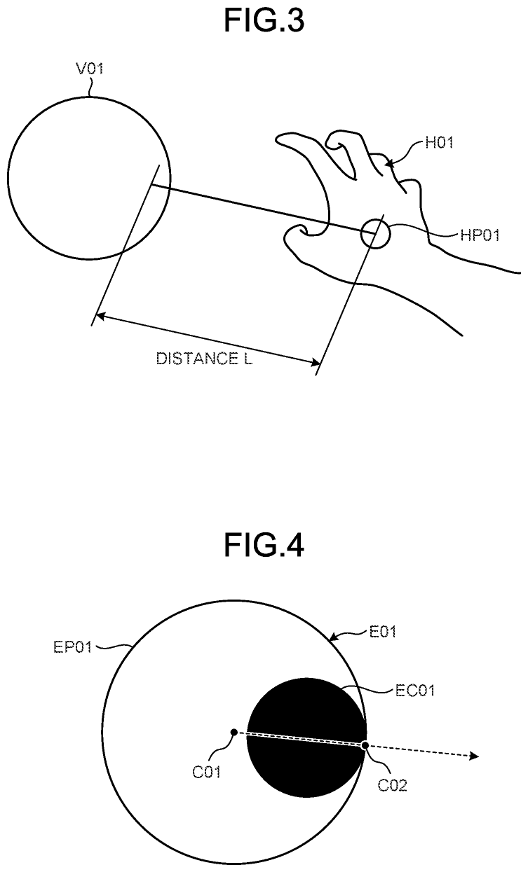

The distance acquired by the information processing apparatus 100 will be described below with reference to FIG. 3. FIG. 3 is a third diagram illustrating the overview of the information processing according to the first embodiment of the present disclosure. In the example illustrated in FIG. 3, a relationship among the hand H01 of the user, a distance L acquired by the acquisition unit 32, and the virtual object V01 are schematically illustrated.

If the information processing apparatus 100 recognizes the hand H01, the information processing apparatus 100 sets the arbitrary coordinate HP01 included in the recognized hand H01. For example, the coordinate HP01 is set in approximately the center or the like of the recognized hand H01. Alternatively, a part of the hand H01 that is closest to the virtual object V01 in the region of the recognized hand H01 may be set as the coordinate HP01. Meanwhile, an update frequency of the coordinate HP01 may be set to be lower than a detection frequency of a signal value of the sensor 20 so that variation in the signal value of the sensor 20 may be absorbed. Further, the information processing apparatus 100 sets, in the virtual object V01, a coordinate at which the hand of the user is recognized as touching the virtual object V01. In this case, the information processing apparatus 100 sets a plurality of coordinates to ensure a certain spatial extent, instead of setting only a coordinate of a single point. This is because it is difficult for the user U01 to accurately touch the coordinate of the single point in the virtual object V01, and therefore, by setting a certain spatial range, it is possible to allow the user U01 to relatively easily “touch” the virtual object V01.

Then, the information processing apparatus 100 acquires the distance L between the coordinate HP01 and an arbitrary coordinate that is set in the virtual object V01 (may be any specific coordinate, a central point or a center of gravity of a plurality of coordinates, or the like).

Further, the information processing apparatus 100 changes the display mode of the black part of eye EC01 in the indicator E01 based on the acquired distance L. This will be described with reference to FIG. 4. FIG. 4 is a fourth diagram illustrating the overview of the information processing according to the first embodiment of the present disclosure.

As illustrated in FIG. 4, the indicator E01 includes two overlapping display regions, that is, the sclera EP01 and the black part of eye EC01. The sclera EP01 has a lighter color than the black part of eye EC01, has a wider region than the black part of eye EC01 so as to include the black part of eye EC01, and is semi-transparent. The black part of eye EC01 has a darker color than the sclera EP01 and has a narrower region than the sclera EP01. In an initial state, the black part of eye EC01 is a sphere with a radius that is a half of that of the sclera EP01, for example. In FIG. 4 and other drawings, the pupil of the indicator E01 is referred to as the black part of eye EC01, but the present disclosure is not limited to this example. In other words, a color of the predetermined region corresponding to the pupil in the indicator E01 need not always be black, and may be represented by various possible shapes and colors of living organisms. It is of course possible that the indicator E01 is a reproduction of an eyeball of a generally-known virtual character, instead of an eyeball of an actual living organism.

In the example illustrated in FIG. 4, a point C01 is a center of the sclera EP01. Further, a point C02 is a point at which the sclera EP01 and the black part of eye EC01 come into contact with each other. A direction that connects the point C01 and the point C02 and goes from the point C01 to the point C02 corresponds to a direction in which the indicator E01 “views” the user U01. In other words, the direction that goes from the point C01 to the point C02 is the direction indicated by the eyeball-shaped indicator E01. Meanwhile, it may be possible to set a straight line connecting C01 and the coordinate HP01 in the global coordinate system as an optical axis of the eyeball-shaped indicator E01, and control display of the indicator E01 such that the optical axis passes through the approximate center of the black part of eye EC01 and a surface represented by the black part of eye EC01 is approximately perpendicular to the optical axis.

The information processing apparatus 100 performs control as if the indicator E01 is viewing the hand H01 of the user U01, by changing the display mode of the black part of eye EC01, which will be described later. The user U01 views the indicator E01 and determines whether the hand H01 of the user is recognized by the information processing apparatus 100 or whether the hand H01 of the user is appropriately headed toward the virtual object V01.

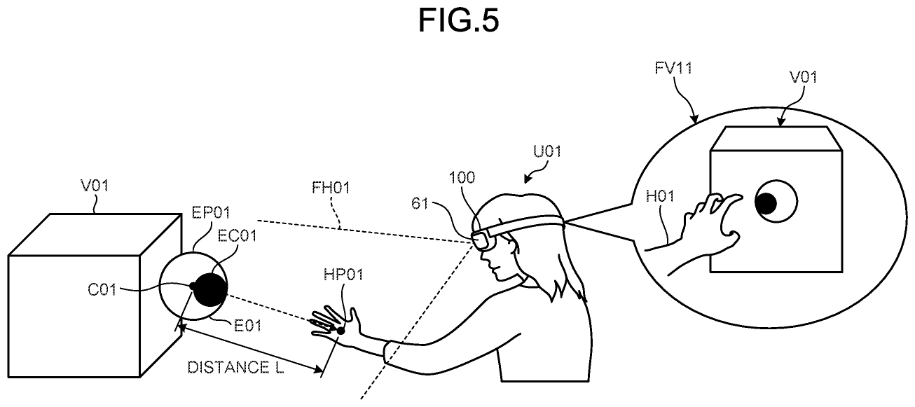

The way of change in the mode of the indicator E01 by the information processing according to the present disclosure will be described below with reference to FIG. 5. FIG. 5 is a fifth diagram illustrating the overview of the information processing according to the first embodiment of the present disclosure.

As illustrated in FIG. 5, the user U01 raises the hand H01 in a range of an angle of view FH01 that is a displayable range of the display unit 61. At this time, the information processing apparatus 100 recognizes the hand H01 of the user. Further, the information processing apparatus 100 acquires a direction between the coordinate HP01 on the hand H01 and the point C01 that is the center of the indicator E01. Then, the information processing apparatus 100 moves the black part of eye EC01 in a direction in which the hand H01 approaches the virtual object V01. Furthermore, the information processing apparatus 100 acquires the distance L between the hand H01 and the virtual object V01. Then, the information processing apparatus 100 changes the size of the black part of eye EC01 based on the distance L.

In this case, as illustrated in the display EV11, the user U01 is able to check a video in which the indicator E01 is viewing the hand H01 that is extended toward the virtual object V01. Accordingly, the user U01 is able to recognize that the hand H01 of the user is recognized and recognize the direction in which the hand H01 approaches the virtual object V01.

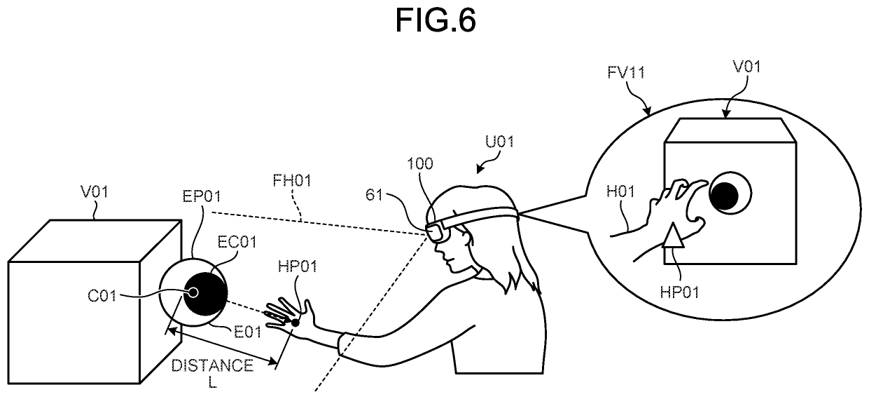

The way of change in a case in which the hand H01 further approaches the virtual object V01 will be described below with reference to FIG. 6. FIG. 6 is a sixth diagram illustrating the overview of the information processing according to the first embodiment of the present disclosure.

In the example illustrated in FIG. 6, the user U01 moves the hand H01 closer to the virtual object V01 as compared to the state illustrated in FIG. 5. For example, the user U01 moves the hand H01 closer such that the distance between the virtual object V01 and the hand H01 becomes smaller than 50 centimeters (cm). In this case, the information processing apparatus 100 continuously changes the size of the black part of eye EC01 on the basis of the change in the distance L between the point C01 and the coordinate HP01. Specifically, the information processing apparatus 100 changes the radius of the black part of eye EC01 such that the size of the black part of eye EC01 increases with a decrease in the value of the distance L.

As illustrated in the display FV11 in FIG. 6, the user U01 is able to visually recognize that the black part of eye EC01 is displayed in a larger size as compared to FIG. 5. Therefore, the user U01 is able to determine that the hand H01 has further approached the virtual object V01. Furthermore, with the change of the display mode as described above, the user U01 gest an impression that the indicator E01 represents an opened eye, and therefore, is able to more intuitively determine that the hand H01 has moved closer to the virtual object V01.

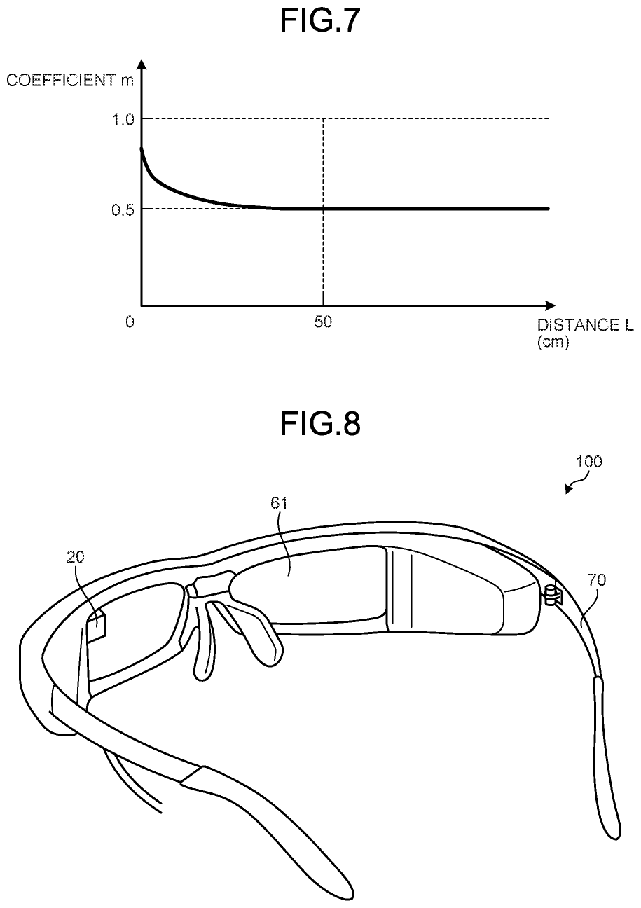

This will be described below with reference to FIG. 7. FIG. 7 is a diagram for explaining an output control process according to the first embodiment of the present disclosure.

A graph illustrated in FIG. 7 represents a relationship between the distance L between the point C01 and the coordinate HP01 and the size of the black part of eye EC01. Here, it is assumed that the size (radius) of the black part of eye EC01 is obtained by, for example, multiplying a “radius of the sclera EP01” by a “coefficient m”. As illustrated in FIG. 7, the information processing apparatus 100 controls display such that if the distance L is equal to or larger than “50 cm”, the radius of the black part of eye EC01 is reduced to a half of the sclera EP01 (the coefficient m=0.5)”. In contrast, if the distance L is smaller than “50 cm”, the information processing apparatus 100 continuously changes display such that the radius of the black part of eye EC01 is gradually increased (the coefficient m>0.5) in inverse proportion to the distance L.

In other words, the information processing apparatus 100 is able to produce an effective representation, such as an opened eye, by changing the display mode of the black part of eye EC01 as indicated by the graph illustrated in FIG. 7. Meanwhile, a change of the value illustrated in FIG. 7 is one example, and setting of the coefficient m and the radius of the black part of eye EC01 are not limited to the example illustrated in FIG. 7 as long as it is possible to give a change as illustrated in FIG. 6 to the display mode of the black part of eye EC01.

As described above, the information processing apparatus 100 acquires the change in the distance L between the real object (for example, the hand H01), which is operated by the user U01 in the real space, and the virtual object (for example, the virtual object V01), which is superimposed in the real space on the display unit 61. Then, the information processing apparatus 100 displays, on the display unit 61, the first display region (for example, the sclera EP01) that is displayed on the virtual object in a superimposed manner and the second display region (for example, the black part of eye EC01) that is displayed in the first display region in a superimposed manner, and continuously changes a display mode of the second display region in accordance with the acquired change in the distance L.

For example, the information processing apparatus 100 may display the eyeball-shaped indicator E01, which is a combination of the sclera EP01 and the black part of eye EC01, on the virtual object V01 in a superimposed manner and change the display mode of the indicator to make it possible to perceive a heading direction of the hand H01 and perceive approach of the hand H01 to the virtual object V01. With this configuration, the information processing apparatus 100 is able to improve the recognition performance of the user U01 with respect to the virtual object V01 that is difficult for the user U01 to recognize and that is superimposed in the real space in the AR technology or the like. Meanwhile, it is experimentally known that human perception of display representing an eyeball is higher than perception of other kinds of display. Therefore, according to the information processing of the present disclosure, the user U01 is able to more intuitively and accurately recognize movement of the hand H01 and recognize movement of the hand H01 without a large burden, as compared to a featureless indicator that simply indicates the distance and the direction. In other words, the information processing apparatus 100 is able to improve usability in the technology, such as AR, using an optical system.

A configuration of the information processing apparatus 100 that implements the information processing as described above will be described in detail below with reference to the drawings.

1-2. External Appearance of Information Processing Apparatus According to First Embodiment

First, an external appearance of the information processing apparatus 100 will be described with reference to FIG. 8. FIG. 8 is a diagram illustrating the external appearance of the information processing apparatus 100 according to the first embodiment of the present disclosure. As illustrated in FIG. 8, the information processing apparatus 100 includes the sensor 20, the display unit 61, and a holding unit 70.

The holding unit 70 is a component corresponding to a glasses frame. Further, the display unit 61 is a component corresponding to glasses lenses. The holding unit 70 holds the display unit 61 such that the display unit 61 is located in front of the eyes of the user when the information processing apparatus 100 is worn by the user.

The sensor 20 is a sensor that detects various kinds of environmental information. For example, the sensor 20 has a function as a recognition camera for recognizing a space in front of the eyes of the user. In the example illustrated in FIG. 8, only the single sensor 20 is illustrated, but the sensor 20 may be what is called a stereo camera that is included in each part of the display unit 61.

The sensor 20 is held by the holding unit 70 so as to be oriented in a direction in which the head of the user is oriented (in other words, in the front direction of the user). Based on the configuration as described above, the sensor 20 recognizes a subject that is located in front of the information processing apparatus 100 (in other words, a real object that is located in a real space). Further, the sensor 20 is able to acquire an image of the subject that is located in front of the user, and calculate a distance from the information processing apparatus 100 (in other words, a position of a viewpoint of the user) to the subject, on the basis of disparity between images captured by the stereo camera.

Meanwhile, configurations and methods are not specifically limited as long as it is possible to measure the distance between the information processing apparatus 100 and the subject. As a specific example, it may be possible to measure the distance between the information processing apparatus 100 and the subject by a method using a multiple camera stereo, motion parallax, time of flight (TOF), Structured Light, or the like. The TOF is a method of projecting light, such as infrared, to the subject, measuring, for each of pixels, a time taken until the projected light is returned by being reflected by the subject, and obtaining an image (what is called a distance image) that includes a distance (depth) to the subject on the basis of a measurement result. Further, Structured Light is a method of applying a pattern to the subject using light, such as infrared, capturing an image of the pattern, and obtaining a distance image including a distance (depth) to the subject on the basis of a change in the pattern obtained from an imaging result. Furthermore, the motion parallax is a method of measuring a distance to the subject based on a parallax even in what is called a monocular camera. Specifically, the camera is moved to capture images of the subject from different viewpoints, and the distance to the subject is measured based on disparities between the captured images. Meanwhile, by causing various sensors to recognize a moving distance and a moving direction of the camera at this time, it is possible to more accurately measure the distance to the subject. A system of the sensor 20 (for example, a monocular camera, a stereo camera, or the like) may be appropriately changed depending on the method of measuring the distance.

Further, the sensor 20 may detect information on the user him/herself, in addition to information on the front of the user. For example, the sensor 20 is held by the holding unit 70 such that when the information processing apparatus 100 is worn on the head of the user, the eyeballs of the user are located within an imaging range. Furthermore, the sensor 20 recognizes a direction in which a line of sight of the right eye is oriented, on the basis of the captured image of the right eye of the user and a positional relationship with the right eye. Similarly, the sensor 20 recognizes a direction in which a line of sight of the left eye is oriented, on the basis of the captured image of the left eye of the user and a positional relationship with the left eye.

Moreover, the sensor 20 may have a function to detect various kinds of information on movement of the user, such as orientation, inclination, and motion of the body of the user and a moving speed, in addition to the functions as the recognition camera. Specifically, the sensor 20 detects, as the information on the movement of the user, information on the head or the posture of the user, motion (acceleration or angular velocity) of the head or the body of the user, a direction of a visual field, a speed of movement of the viewpoint, or the like. For example, the sensor 20 functions as various motion sensors, such as a three-axis acceleration sensor, a gyro sensor, or a speed sensor, and detects information on the movement of the user. More specifically, the sensor 20 detects, as motion of the head of the user, a component in each of a yaw direction, a pitch direction, and a roll direction, and detects a change in at least one of the position and the posture of the head of the user. Meanwhile, the sensor 20 need not always be included in the information processing apparatus 100, but may be an external sensor that is connected to the information processing apparatus 100 in a wired or wireless manner, for example.

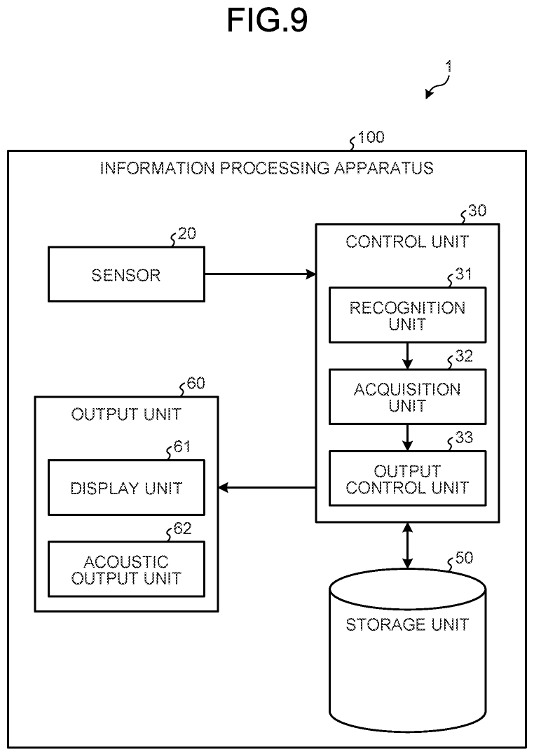

Furthermore, while not illustrated in FIG. 8, the information processing apparatus 100 may include an operation unit that receives input from the user. For example, the operation unit may include an input device, such as a touch panel or a button. For example, the operation unit may be held at a position corresponding to a temple of glasses. Moreover, the information processing apparatus 100 may include an output unit (a speaker or the like) that outputs a signal, such as voice, on an exterior thereof. Furthermore, the information processing apparatus 100 includes a built-in control unit 30 (see FIG. 9) that performs the information processing according to the present disclosure.

Based on the configuration as described above, the information processing apparatus 100 according to the present embodiment recognizes a change in the position or the posture of the user him/herself in the real space, in accordance with motion of the head of the user. Furthermore, the information processing apparatus 100 displays, on the display unit 61, a content in which a virtual content (in other words, a virtual object) is superimposed on a real object that is located in the real space by using what is called the AR technology, on the basis of the recognized information.

In this case, the information processing apparatus 100 may estimate a position and a posture of the subject apparatus in the real space on the basis of the SLAM technology or the like, for example, and may use an estimation result for a process of displaying the virtual object.

The SLAM is a technology for performing self-location estimation and generation of an environment map in parallel, by using an imaging unit, such as a camera, various sensors, an encoder, and the like. As a more specific example, in the SLAM (in particular, in the Visual SLAM), a three-dimensional shape of a captured scene (or a subject) is sequentially reproduced on the basis of the captured video. Then, by associating a reproduction result of the captured scene with a detection result of a position and a posture of the imaging unit, a map of a surrounding environment is generated and the position and the posture of the imaging unit (in the example illustrated in FIG. 8, the sensor 20, in other words, the information processing apparatus 100) in the environment are estimated. Meanwhile, as for estimation of the position and the posture of the information processing apparatus 100, as described above, it is possible to detect various kinds of information by using various sensor functions of an acceleration sensor, an angular velocity sensor, and the like included in the sensor 20, and estimate the position and the posture as information indicating a relative change based on detection results. The estimation method is not specifically limited to the method based on the detection results of various sensors, such as the acceleration sensor and the angular velocity sensor, as long as it is possible to estimate the position and the posture of the information processing apparatus 100.

Furthermore, examples of the head-mounted display (HMD) that is applicable as the information processing apparatus 100 include an optical see-through HMD, a video see-through HMD, and a retinal projection HMD.

The see-through HMD uses, for example, a half mirror or a transparent light guide plate, holds a virtual-image optical system including a transparent light guide unit or the like in front of the eyes of the user, and displays an image inside the virtual-image optical system, for example. Therefore, the user who is wearing the see-through HMD is able to recognize external scenery in the visual field while viewing the image that is displayed inside the virtual-image optical system. With this configuration, the see-through HMD is able to superimpose an image of a virtual object on an optical image of a real object that is located in the real space, in accordance with a recognition result of at least one of a position and a posture of the see-through HMD, on the basis of the AR technology, for example. Meanwhile, specific examples of the see-through HMD include what is called a glasses wearable device, in which parts corresponding to lenses of glasses are configured as a virtual-image optical system. For example, the information processing apparatus 100 illustrated in FIG. 8 corresponds to one example of the see-through HMD.

Moreover, as for the video see-through HMD, when the see-through HMD is worn on the head or a facial portion of the user, the video see-through HMD is mounted so as to cover the eyes of the user, and a display unit, such as a display, is held in front of the eyes of the user. Furthermore, the video see-through HMD includes an imaging unit for capturing an image of surrounding scenery, and causes the display unit to display the image that represents the scenery in front of the user and that is captured by the imaging unit. With this configuration, the user who is wearing the video see-through HMD is able to check external scenery by the image displayed on the display unit, while it is difficult for the user to directly recognize the external scenery in the visual field. Moreover, the video see-through HMD may superimpose a virtual object on the image of the external scenery in accordance with a recognition result of at least one of a position and a posture of the video see-through HMD on the basis of the AR technology, for example.

The retinal projection HMD includes a projection unit that is held in front of the eyes of the user, and projects an image from the projection unit to the eyes of the user such that the image is superimposed on external scenery. Specifically, in the retinal projection HMD, an image is directly projected from the projection unit to retinas of the eyes of the user, and the image is formed on the retinas. With this configuration, even a user with myopia or hyperopia is able to view a clearer video. Furthermore, the user who is wearing the retinal projection HMD is able to recognize the external scenery in the visual field while viewing the image that is projected from the projection unit. With this configuration, the retinal projection HMD is able to superimpose an image of a virtual object on an optical image of a real object that is located in the real space, in accordance with a recognition result of at least one of a position and a posture of the retinal projection HMD on the basis of the AR technology, for example.

In the above description, one example of the external configuration of the information processing apparatus 100 according to the first embodiment has been explained based on the assumption that the AR technology is adopted; however, the exterior configuration of the information processing apparatus 100 is not limited to the example as described above. For example, if it is assumed to adopt the VR technology, the information processing apparatus 100 may be configured as an HMD that is called an immersive HMD. The immersive HMD is worn so as to cover the eyes of the user and a display unit, such as a display, is held in front of the eyes of the user, similarly to the video see-through HMD. Therefore, it is difficult for the user who is wearing the immersive HMD to directly recognize the external scenery in the visual field (in other words, the real space), and only a video that is displayed on the display unit appears in the visual field. In this case, the immersive HMD performs control of displaying both of a captured image of the real space and the superimposed virtual object on the display unit. In other words, the immersive HMD superimposes the virtual object on the captured image of the real space and displays both of the real space and the virtual object on the display, instead of superimposing the virtual object in the transparent real space. Even with this configuration, it is possible to implement the information processing according to the present disclosure.

1-3. Configuration of Information Processing Apparatus According to First Embodiment

An information processing system 1 that performs the information processing according to the present disclosure will be described below with reference to FIG. 9. In the first embodiment, the information processing system 1 includes the information processing apparatus 100. FIG. 9 is a diagram illustrating a configuration example of the information processing apparatus 100 according to the first embodiment of the present disclosure.

As illustrated in FIG. 9, the information processing apparatus 100 includes the sensor 20, the control unit 30, a storage unit 50, and an output unit 60.

The sensor 20 is, as described above with reference to FIG. 8, a device or an element that detects various kinds of information on the information processing apparatus 100.

The control unit 30 is implemented by, for example, causing a central processing unit (CPU), a micro processing unit (MPU), or the like to execute a program (for example, an information processing program according to the present disclosure) stored in the information processing apparatus 100 by using a random access memory (RAM) or the like as a work area. Further, the control unit 30 is a controller, and may be implemented by an integrated circuit, such as an application specific integrated circuit (ASIC) or a field programmable gate array (FPGA).

As illustrated in FIG. 9, the control unit 30 includes a recognition unit 31, the acquisition unit 32, and an output control unit 33, and implements or executes functions and operation of the information processing as described below. Meanwhile, the internal configuration of the control unit 30 is not limited to the configuration illustrated in FIG. 9, and other configurations may be adopted as long as it is possible to perform the information processing as described below. Meanwhile, the control unit 30 may be connected to a predetermined network in a wired or wireless manner by using, for example, a network interface card (NIC) or the like, and receive various kinds of information from an external server or the like via the network.

The recognition unit 31 performs a process of recognizing various kinds of information. For example, the recognition unit 31 controls the sensor 20, and detects various kinds of information by using the sensor 20. Further, the recognition unit 31 performs a process of recognizing various kinds of information on the basis of the information detected by the sensor 20.

For example, the recognition unit 31 recognizes a position of the hand of the user in the space. Specifically, the recognition unit 31 recognizes the position of the hand of the user on the basis of a video that is captured by the recognition camera that is one example of the sensor 20. The recognition unit 31 may perform a hand recognition process as described above by using various known sensing techniques.

For example, the recognition unit 31 analyzes a captured image that is acquired by a camera included in the sensor 20, and performs a process of recognizing a real object that is present in the real space. For example, the recognition unit 31 matches an image feature amount that is extracted from the captured image to an image feature amount of a known real object (specifically, an object operated by the user, such as the hand of the user) that is stored in the storage unit 50. Then, the recognition unit 31 identifies the real object in the captured image, and recognizes the position in the captured image. Further, the recognition unit 31 analyzes a captured image that is captured by the camera included in the sensor 20, and acquires three-dimensional shape information on the real space. For example, the recognition unit 31 may recognize a three-dimensional shape of the real space by performing a stereo matching method with respect to a plurality of images that are simultaneously acquired or performing a Structure from Motion (SfM) method, the SLAM method, or the like with respect to a plurality of images that are chronologically acquired, and acquire the three-dimensional shape information. Furthermore, if the recognition unit 31 is able to acquire the three-dimensional shape information on the real space, the recognition unit 31 may recognize a three-dimensional position, a three-dimensional shape, a three-dimensional size, and a three-dimensional posture of the real object.

Moreover, the recognition unit 31 may recognize user information on the user and environmental information on an environment in which the user is present, on the basis of sensing data detected by the sensor 20, in addition to recognition of the real object.

The user information includes, for example, behavior information indicating a behavior of the user, motion information indicating motion of the user, biological information, gaze information, and the like. The behavior information is, for example, information indicating a current behavior, such as standing still, walking, running, driving a vehicle, going up and down stairs, or the like, of the user, and is recognized by analyzing sensing data, such as acceleration, that is acquired by the sensor 20. Further, the motion information is information on a moving speed, a moving direction, moving acceleration, approach to a position of a content, or the like, and is recognized by sensing data, such as acceleration or GPS data, that is acquired by the sensor 20. Furthermore, the biological information is information on a heart rate, body temperature, diaphoresis, blood pressure, pulse, breathing, blink, eyeball motion, brain waves, or the like, and is recognized based on sensing data obtained by a biological sensor that is included in the sensor 20. Moreover, the gaze information is information on gaze of the user, such as a line of sight, a gaze point, a focal point, or convergence of eyes, and is recognized based on sensing data obtained by a visual sensor that is included in the sensor 20.

Furthermore, the environmental information includes, for example, information on a surrounding situation, a place, illuminance, altitude, air temperature, a direction of the wind, air volume, time, or the like. The information on the surrounding situation is recognized by analyzing sensing data obtained by a camera or a microphone that is included in the sensor 20. Moreover, the information on the place may be, for example, information indicating characteristics of a place, such as an indoor place, an outdoor place, a place under water, or a dangerous place, where the user is present, or may be information on a place having certain meaning to the user, such as a home, an office, a familiar place, or a first visited place. The information on the place is recognized by analyzing sensing data obtained by a camera, a microphone, a GPS sensor, an illumination sensor, or the like that is included in the sensor 20. Furthermore, the information on the illuminance, the altitude, the air temperature, the direction of the wind, the air volume, and the time (for example, a GPS time) may similarly be recognized based on sensing data obtained by various sensors that are included in the sensor 20.

The acquisition unit 32 acquires a change in the distance between the real object that is operated by the user in the real space and a virtual object that is a virtual object superimposed in the real space on the display unit 61.

The acquisition unit 32 acquires, as the real object, information on the hand of the user that is sensed by the sensor 20. In other words, the acquisition unit 32 acquires a change in the distance between the hand of the user and the virtual object on the basis of a space coordinate position of the hand of the user recognized by the recognition unit 31 and a space coordinate position of the virtual object displayed on the display unit 61.

For example, as illustrated in FIG. 3, if the recognition unit 31 recognizes the hand H01, the acquisition unit 32 sets the arbitrary coordinate HP01 included in the recognized hand H01. Further, the acquisition unit 32 sets, in the virtual object V01, a coordinate at which the hand of the user is recognized as touching the virtual object V01. Then, the acquisition unit 32 acquires the distance L between the coordinate HP01 and the arbitrary coordinate set in the virtual object V01. For example, the acquisition unit 32 acquires a change in the distance L in real time, for each of frames captured by the sensor 20 (for example, 30 times per second or 60 times per second).

A process that is performed when the acquisition unit 32 acquires the distance between the real object and the virtual object will be described below with reference to FIG. 10 to FIG. 12.

FIG. 10 is a first diagram for explaining the information processing according to the first embodiment of the present disclosure. FIG. 10 illustrates an angle of view in which the information processing apparatus 100 recognizes the object when viewed from a position of the head of the user. A region FV01 indicates a region in which the sensor 20 (recognition camera) is able to recognize the object. In other words, the information processing apparatus 100 is able to recognize a space coordinate of an object as long as the object is present within the region FV01.

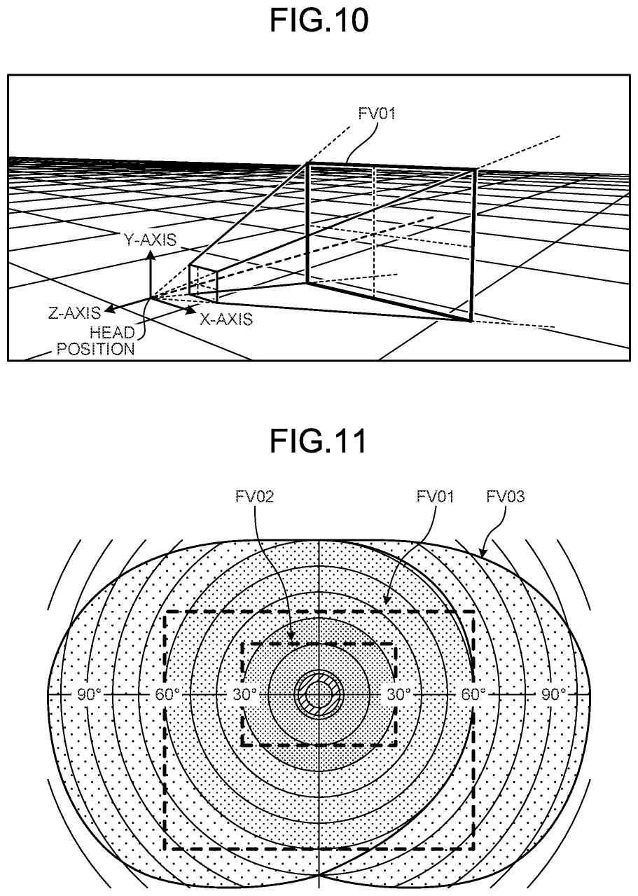

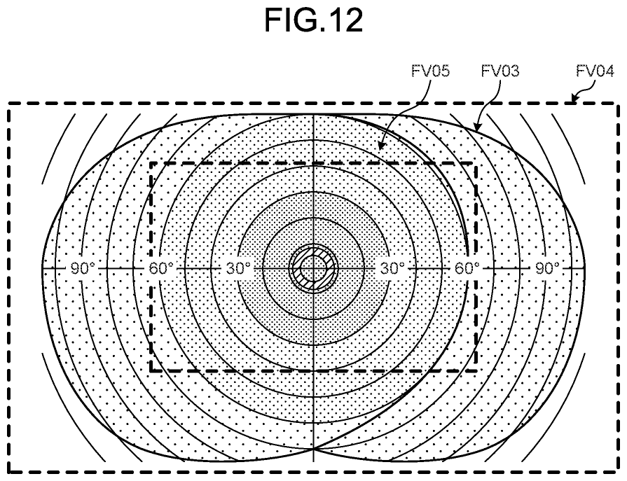

An angle of view that can be recognized by the information processing apparatus 100 will be described below with reference to FIG. 11. FIG. 11 is a second diagram for explaining the information processing according to the first embodiment of the present disclosure. FIG. 11 schematically illustrates a relationship between the region FV01 that indicates the angle of view covered by the recognition camera, a region FV02 that is a display region of the display (the display unit 61), and a region FV03 that indicates an angle of view of a visual field of each of users.

When the recognition camera covers the region FV01, and if the real object is present within the region FV01, the acquisition unit 32 is able to acquire the distance between the real object and the virtual object. In contrast, the acquisition unit 32 is not able to recognize the real object if the real object is located outside the region FV01, and therefore is not able to acquire the distance between the real object and the virtual object. In this case, the output control unit 33 (to be described later) may provide an output for notifying the user that the real object is not recognized. Accordingly, the user is able to recognize that the hand is not recognized by the information processing apparatus 100 although the hand appears in the visual field of the user.

In contrast, in some cases, a cover range of the recognition camera may be wider than the angle of view of the visual field of the user. This will be described below with reference to FIG. 12. FIG. 12 is a third diagram for explaining the information processing according to the first embodiment of the present disclosure.

In the example illustrated in FIG. 12, it is assumed that a region FV04 covered by the recognition camera is wider than the region FV03 indicating the angle of view of the visual field of the user. Meanwhile, a region FV05 illustrated in FIG. 12 indicates a display region of a display in a case where the range covered by the recognition camera is increased.

As illustrated in FIG. 12, if the region FV04 covered by the recognition camera is wider than the region FV03 indicating the angle of view of the visual field of the user, the information processing apparatus 100 recognizes presence of the hand although the user is not able to view his/her hand. In contrast, as illustrated in FIG. 11, if the region FV02 covered by the recognition camera is smaller than the region FV03, the information processing apparatus 100 does not recognize presence of the hand although the user is able to view his/her hand. In other words, in the technology, such as the AR technology, for recognizing an object present in the real space, in some cases, a conflict may occur between perception by the user and recognition by the information processing apparatus 100. As illustrated in FIG. 12, even if the range covered by the recognition camera is increased, the information processing apparatus 100 is able to give a predetermined output (feedback) indicating that the hand of the user is recognized. Therefore, it is possible to prevent a situation in which the user may feel discomfort about whether user's hand is recognized or a situation in which recognition is not performed even when operation is performed.

As described above, the acquisition unit 32 may acquire the location information indicating the position of the real object by using the sensor 20 having a detection range that exceeds the angle of view of the display unit 61. In other words, the acquisition unit 32 is able to indicate a recognition result of the hand of the user in the three-dimensional space by using the indicator E01 of the virtual object even if the real object is not included in the angle of view of the display.

Meanwhile, the acquisition unit 32 may acquire location information on the head of the user if it is difficult to acquire the location information indicating the position of the real object. In this case, the output control unit 33 may give an output indicating that the real object is not recognized. Specifically, the output control unit 33 may perform control of displaying an initial state without specifically changing the indicator E01.

Furthermore, the acquisition unit 32 may acquire the location information on the virtual object in the display unit 61, in addition to the real object. In this case, the output control unit 33 may change a mode of an output signal in accordance with approach of the virtual object from the inside of the angle of view of the display unit 61 to a boundary between the inside and the outside of the angle of view of the display unit 61.

Moreover, the acquisition unit 32 may acquire information indicating transition from a state in which the sensor 20 is not able to detect the real object to a state in which the sensor 20 is able to detect the real object. Furthermore, the output control unit 33 may give a certain feedback if the information indicating transition to the state in which the sensor 20 is able to detect the real object is acquired. For example, if the sensor 20 newly detects a hand of a user, the output control unit 33 may output a sound effect indicating the detection.

Alternatively, if the sensor 20 newly detects a hand of a user, the output control unit 33 may perform a process of displaying the indicator E01 that has been hidden. With this configuration, it is possible to eliminate a state in which the user feels discomfort about whether user's hand is recognized.

The output control unit 33 displays, on the display unit 61, the first display region that is displayed in a superimposed manner on the virtual object and the second display region that is displayed in a superimposed manner on the first display region, and continuously changes the display mode of the second display region in accordance with the change in the distance acquired by the acquisition unit 32.

Meanwhile, the output control unit 33 displays the first display region and the second display region in a superimposed manner on the surface of the virtual object. For example, the output control unit 33 displays a combination (the indicator E01) of the first display region and the second display region such that an arbitrary coordinate included in the surface of the virtual object and the centers of the first display region and the second display region overlap with one another. Further, the output control unit 33 need not always display the indicator E01 on the surface of the virtual object, but may display the indicator E01 such that the indicator is embedded in the virtual object.

The output control unit 33 may perform various processes as a change in the display mode of the second display region. As one example, the output control unit 33 continuously changes the size of the second display region in accordance with the change in the distance acquired by the acquisition unit 32. Specifically, as illustrated in FIG. 6 and FIG. 7, the output control unit 33 continuously changes the radius of the black part of eye EC01 in accordance with the change in the distance acquired by the acquisition unit 32. With this configuration, the output control unit 33 is able to impressively change the display mode, such as enlargement of the black part of eye EC01 with approach of the hand of the user.

Meanwhile, the output control unit 33 may stop control of continuously changing the display mode of the second display region if the distance between the real object and the virtual object becomes equal to or smaller than a predetermined threshold (second threshold). For example, as illustrated in FIG. 7, the output control unit 33 stops giving a feedback that is for continuously changing the size of the black part of eye EC01 if the distance L reaches zero. With this configuration, it is possible to reproduce a contraction limit of the pupil of the indicator E01 and naturally notify the user that the hand of the user will soon touch the virtual object. Then, the output control unit 33 may output a specific sound effect indicating that the hand of the user touches the virtual object or may perform a display process indicating that the hand of the user touches the virtual object, for example.

Furthermore, the output control unit 33 may change the display mode of the first display region or the second display region on the basis of the location information on the real object acquired by the acquisition unit 32. For example, the output control unit 33 may display the indicator E01 in response to recognition of the real object by the recognition unit 31 or acquisition of the distance between the real object and the virtual object by the acquisition unit 32. With this configuration, the user is able to easily recognize that user's hand is recognized.

Moreover, the output control unit 33 may move the second display region such that the real object is located face-to-face in the direction in which the real object approaches the virtual object, on the basis of the location information on the real object acquired by the acquisition unit 32. In other words, the output control unit 33 may be able to move the predetermined region corresponding to the pupil such that the predetermined region becomes approximately perpendicular to a straight line (optical axis) that connects the position of the real object detected by the sensor and the position of the sensory organ object.

For example, the output control unit 33 may acquire a vector that connects the coordinate representing the central point of the black part of eye EC01 and the coordinate representing the real object, and perform a process of moving the central point of the black part of eye EC01 by an arbitrary distance in the direction of the vector. Accordingly, the user is able to visually recognize as if the black part of eye EC01 is viewing user's hand when the hand that the user is moving approaches the virtual object, and recognize that user's hand is correctly moved toward the virtual object. Meanwhile, the output control unit 33 may cause the black part of eye EC01 to be inscribed in the sclera EP01 even if the black part of eye EC01 is moved at a maximum. With this configuration, the output control unit 33 is able to prevent the black part of eye EC01 from moving to the outside of the sclera EP01.

Furthermore, the output control unit 33 continuously changes the radius of the black part of eye EC01 in accordance with approach of the hand as described above, and thereafter may adjust the position of the black part of eye EC01.

As for the process as described above, if, for example, the central coordinate of the black part of eye EC01 is represented by M, the changed radius is represented by r, the coordinate of the central point of the sclera EP01 (origin) is represented by O, and the radius is represented by R, the coordinate of the central point of the moved black part of eye EC01 is represented by Expression (1) below.

$$\vec{OM} + ( R - r ) \cdot \frac{\vec{MT}}{\vert \vec{MT} \vert} \qquad ( 1 )$$

By moving the central point of the black part of eye EC01 on the basis of Expression (1) above, the output control unit 33 is able to realize display as if the largely opened black part of eye EC01 is viewing the hand of the user.

Meanwhile, if it is difficult to acquire the location information on the position of the real object, the output control unit 33 may change the display mode of the first display region or the second display region on the basis of the location information on the head of the user acquired by the acquisition unit 32.

For example, the output control unit 33 identifies the coordinate representing the head of the user on the basis of the location information on the head of the user. For example, the output control unit 33 identifies, as the coordinate representing the head of the user, an arbitrary coordinate in the vicinity of the center of a glasses frame that is the exterior of the information processing apparatus 100. Then, the output control unit 33 moves the position of the center of the black part of eye EC01 on the basis of a vector that connects the center of the indicator E01 and the coordinate representing the head of the user. Accordingly, the output control unit 33 is able to realize display as if the eyeball of the indicator E01 is viewing the user. Further, while the eyeball is viewing the user, the user is able to recognize that the hand of the user is not recognized by the information processing apparatus 100.

Meanwhile, the output control unit 33 may perform the output control process as described above, on the basis of information that is defined in advance, for example. For example, the output control unit 33 may refer to the storage unit 50, and perform the output control process based on various output control methods as described above, and a definition file in which the calculation method as indicated by Expression (1) above is stored.

The storage unit 50 is realized by, for example, a semiconductor memory element, such as a RAM or a flash memory, or a storage device, such as a hard disk or an optical disk. The storage unit 50 is a storage region for temporarily or permanently storing various kinds of data. For example, the storage unit 50 may store therein data (for example, the information processing program according to the present disclosure) used by the information processing apparatus 100 to implement various functions. Furthermore, the storage unit 50 may store therein data (for example, a library) for executing various applications, management data for managing various kinds of setting, and the like.

The output unit 60 includes the display unit 61 and an acoustic output unit 62, and outputs various kinds of information in response to control by the output control unit 33. For example, the display unit 61 is a display or the like for displaying a virtual object that is superimposed in the transparent real space. Further, the acoustic output unit 62 is a speaker or the like for outputting a predetermined voice signal.

1-4. Flow of Information Processing According to First Embodiment

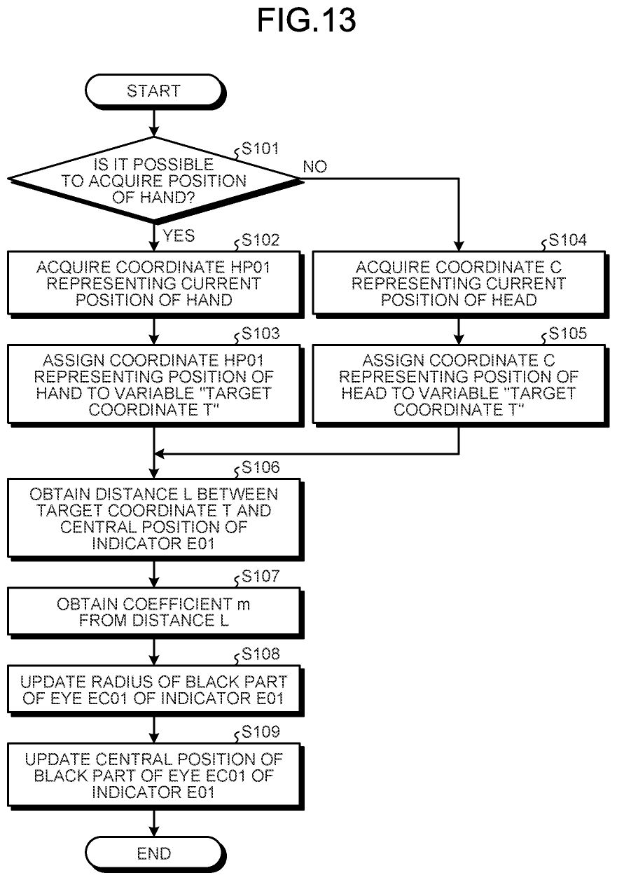

The flow of information processing according to the first embodiment will be described below with reference to FIG. 13. FIG. 13 is a flowchart illustrating the flow of a process according to the first embodiment of the present disclosure.

As illustrated in FIG. 13, the information processing apparatus 100 first determines whether it is possible to acquire the position of the hand of the user by using the sensor 20 (Step S101). If it is possible to acquire the position of the hand of the user (Step S101; Yes), the information processing apparatus 100 acquires the coordinate HP01 representing the current position of the hand (Step S102). Subsequently, the information processing apparatus 100 assigns the coordinate HP01 representing the position of the hand to a variable “target coordinate” (Step S103). Meanwhile, the variable described herein is a variable for executing the information processing according to the first embodiment, and is, for example, a value (coordinate) used to calculate a distance or a direction to the indicator E01.

In contrast, if it is difficult to acquire the position of the hand of the user (Step S101; No), the information processing apparatus 100 acquires a coordinate C representing the position of the head, on the basis of current location information on the head of the user (Step S104). Subsequently, the information processing apparatus 100 assigns the coordinate C representing the position of the head to the variable “target coordinate” (Step S105).

Then, the information processing apparatus 100 obtains the distance L between a target coordinate T and the central position of the indicator E01 (Step S106). Further, the information processing apparatus 100 obtains the coefficient m from the distance L on the basis of the graph as illustrated in FIG. 7, for example (Step S107).

Subsequently, the information processing apparatus 100 updates the radius of the black part of eye EC01 of the indicator E01 on the basis of the obtained coefficient m (Step S108). Furthermore, the information processing apparatus 100 updates the central position of the black part of eye EC01 of the indicator E01 on the basis of Expression (1) above (Step S109).

### 2. Second Embodiment

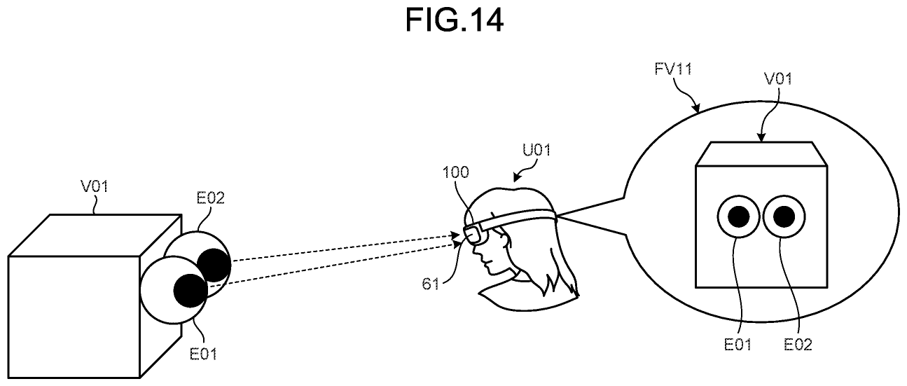

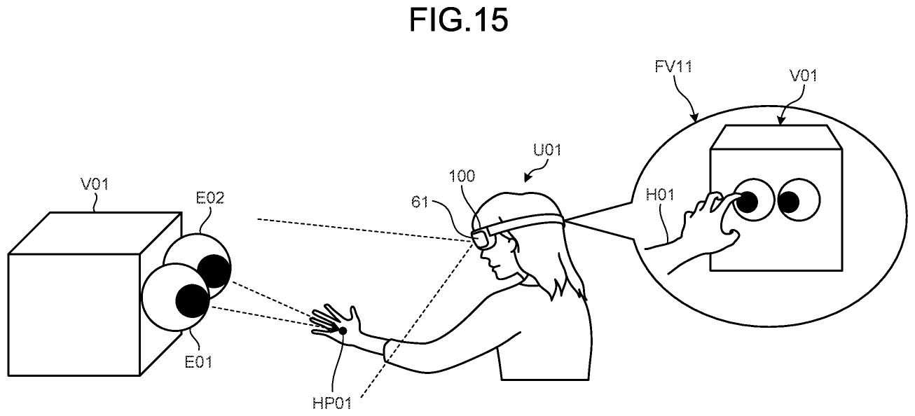

In the first embodiment as described above, the example has been described in which the information processing apparatus 100 displays the single indicator E01 on the virtual object. Here, the information processing apparatus 100 may display a plurality of indicators on the virtual object. This will be described below with reference to FIG. 14 and FIG. 15.

FIG. 14 is a first diagram for explaining the information processing according to the second embodiment of the present disclosure. As illustrated in FIG. 14, the information processing apparatus 100 displays two indicators, that is, the indicator E01 and an indicator E02, on the surface of the virtual object V01.

In this case, as illustrated in the display EV11, the user U01 visually recognize that a pair of eyeballs is attached on the virtual object V01. Meanwhile, the display control process on the pupil of each of the indicator E01 and the indicator E02 is performed in the same manner as in the first embodiment.

A case in which the user U01 raises the hand H01 will be described below with reference to FIG. 15. FIG. 15 is a second diagram for explaining the information processing according to the second embodiment of the present disclosure. In the example illustrated in FIG. 15, similarly to the first embodiment, the information processing apparatus 100 identifies the coordinate HP01 representing the position of the hand H01. Then, a distance between the identified coordinate HP01 and the central point of the indicator E01 and a distance between the identified coordinate HP01 and the central point of the indicator E02 are acquired.

Subsequently, the information processing apparatus 100 changes the display mode of the pupil of each of the indicator E01 and the indicator E02. In this case, as illustrated in the display FV11, the user U01 is able to recognize the indicator E01 and the indicator E02 as motion of the eyeballs with convergence like human eyes. Meanwhile, a display control process that represents the convergence is realized based on a difference between the direction or the distance from the coordinate HP01 to the central point of the indicator E01 and the direction or the distance from the coordinate HP01 to the central point of the indicator E02.

As described above, the information processing apparatus 100 according to the second embodiment displays, side by side, the plurality of combinations of the first display region and the second display region on the surface of the virtual object. Therefore, the information processing apparatus 100 according to the second embodiment is able to perform display that represents motion of the human eyeballs in a better manner, so that it is possible to further improve performance of intuitive recognition of motion of the hand H01.

### 3. Third Embodiment

A third embodiment will be described below. In information processing according to the third embodiment of the present disclosure, an object other than a hand of a user is recognized as a real object.

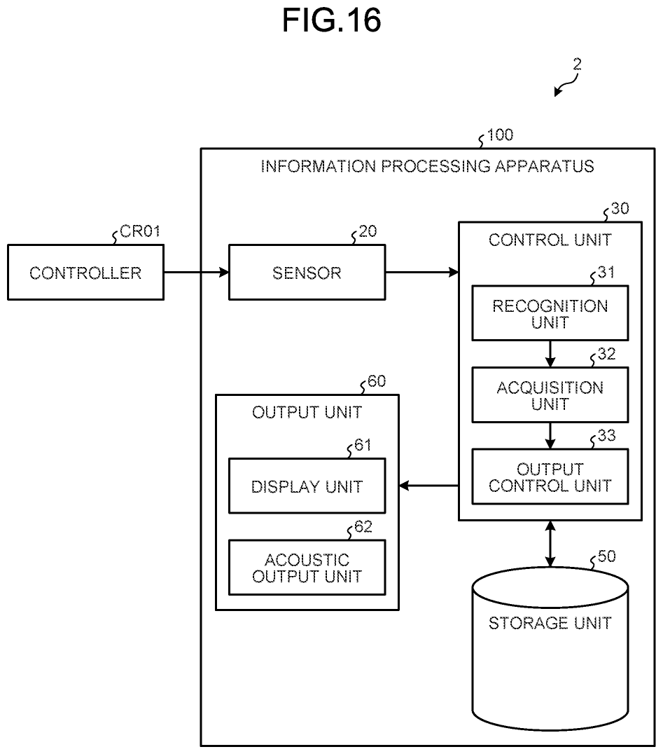

An information processing system 2 according to the third embodiment will be described below with reference to FIG. 16. FIG. 16 is a diagram illustrating a configuration example of the information processing system 2 according to the third embodiment of the present disclosure. As illustrated in FIG. 16, the information processing system 2 according to the third embodiment includes the information processing apparatus 100 and a controller CR01. Meanwhile, explanation on the same components common as those of the first embodiment and the second embodiment will be omitted.

The controller CR01 is an information equipment that is connected to the information processing apparatus 100 by wire or a wireless network. The controller CR01 is, for example, an information equipment that is operated by the user who is wearing the information processing apparatus 100 while being held in the user's hand, and detects motion of the hand of the user and information that is input to the controller CR01 by the user. Specifically, the controller CR01 controls a built-in sensor (for example, various motion sensors, such as a three-axis acceleration sensor, a gyro sensor, and a speed sensor), and detects a three-dimensional position, a speed, and the like of the controller CR01. Then, the controller CR01 transmits the detected three-dimensional position, the detected speed, and the like to the information processing apparatus 100. Meanwhile, the controller CR01 may transmit the three-dimensional position and the like that are detected by an external sensor, such as an external camera. Further, the controller CR01 may transmit information paired with the information processing apparatus 100, location information (coordinate information) on the subject device, or the like, on the basis of a predetermined communication function.

The information processing apparatus 100 according to the third embodiment recognizes, as the real object, not only the hand of the user, but also the controller CR01 operated by the user. Then, the information processing apparatus 100 changes a display mode of the second display region (for example, the black part of eye EC01) on the basis of a change in a distance between the controller CR01 and the virtual object. In other words, the acquisition unit 32 according to the third embodiment acquires a change in the distance between one of the hand of the user and the controller CR01 operated by the user, which are sensed by the sensor 20, and the virtual object. Meanwhile, the information processing apparatus 100 may acquire location information on the controller CR01 by using the sensor 20, and perform a process of changing the display modes of the first display region and the second display region on the basis of the acquired location information.

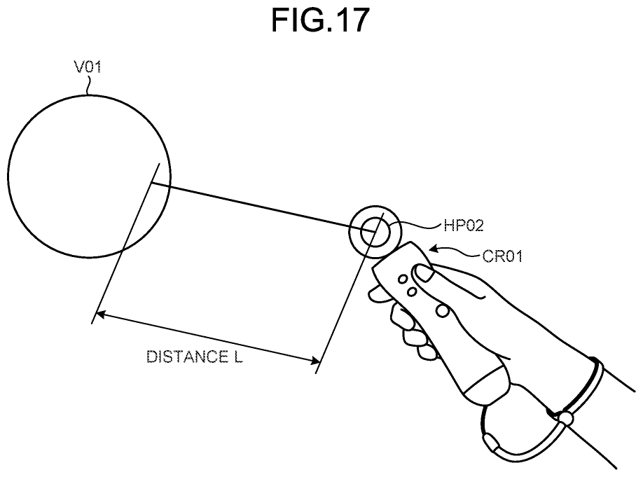

An acquisition process according to the third embodiment will be described below with reference to FIG. 17. FIG. 17 is a diagram for explaining information processing according to the third embodiment of the present disclosure. In the example illustrated in FIG. 17, a relationship among the controller CR01 operated by the user, the distance L acquired by the acquisition unit 32, and the virtual object V01 is schematically illustrated.

If the recognition unit 31 recognizes the controller CR01, the acquisition unit 32 identifies an arbitrary coordinate HP02 included in the recognized controller CR01. The coordinate HP02 is a recognition point of the controller CR01 that is set in advance, and is a point that can easily be recognized by the sensor 20 by issuance of a certain signal (infrared signal or the like), for example.

Then, the acquisition unit 32 acquires the distance L between the coordinate HP02 and an arbitrary coordinate (may be any specific coordinate, a central point or a center of gravity a plurality of coordinates, or the like) that is set in the virtual object V01.

In this manner, the information processing apparatus 100 according to the third embodiment may recognize not only the hand of the user, but also a certain object, such as the controller CR01, operated by the user, and may give a feedback based on the recognized information. In other words, the information processing apparatus 100 may recognize not only the hand, but also an object, such as the controller CR01, that can be recognized by using the sensor 20, and perform the information processing according to the present disclosure.

### 4. Modification of Each of Embodiments

The processes according to each of the embodiments as described above may be performed in various different modes other than each of the embodiments as described above.

The indicator E01 may further includes, as a display region different from the black part of eye EC01 and the sclera EP01, a display region (not illustrated) that represents an eyelid. A display area of the eyelid is increased if a distance between the real object and the virtual object further decreases after the distance between the real object and the virtual object becomes equal to or smaller than a predetermined threshold (second threshold). Meanwhile, in controlling display of the eyelid, it may be possible to set a third threshold that is equal to or smaller than the second threshold, in order to determine the distance between the real object and the virtual object. In the present disclosure, a threshold for changing the display area of the eyelid may be referred to as a first threshold. With the control as described above, the user is able to recognize a recognition result of the distance between the virtual object and the real object in a more gradual and natural manner because of reproduction of contraction of the pupil and motion of closing the eyelid of the virtual object.

In the example as described above, the explanation has been given with a focus on a gradual notice of the distance between the real object and the virtual object to the user; however, the present disclosure is not limited to the example as described above. For example, to more naturally reproduce motion of a living organism or a motion of a virtual character, the indicator E01 may close the eyelid before the pupil completely contracts. Alternatively, the indicator E01 may complete motion of closing the eyelid after the pupil completely contracts. Further, if a living organism or a virtual character for which it is difficult to recognize contraction of the pupil is to be displayed, it may be possible to change only the display area of the eyelid without changing the display area of the pupil.

In each of the embodiments as described above, the example has been described in which the information processing apparatus 100 includes a built-in processing unit, such as the control unit 30. However, the information processing apparatus 100 may be divided into, for example, a glasses-type interface unit, an arithmetic unit including the control unit 30, and an operation unit that receives input operation or the like from the user. Further, as described in each of the embodiments, the information processing apparatus 100 is what is called AR glasses if the information processing apparatus 100 includes the display unit 61 that has transparency and that is held in a direction of the line of sight of the user. However, the information processing apparatus 100 may be an apparatus that communicates with the display unit 61 that is an external display and controls display on the display unit 61.

Furthermore, the information processing apparatus 100 may adopt, as the recognition camera, an external camera that is installed in a different place, instead of the sensor 20 that is arranged in the vicinity of the display unit 61. For example, in the AR technology, in some cases, a camera is installed on a ceiling or the like of a place where the user performs an action, to make it possible to capture an image of entire motion of the user who is wearing an AR goggle. In this case, the information processing apparatus 100 may acquire, via a network, a video that is captured by an externally-installed camera, and recognize a position or the like of the hand of the user.

In each of the embodiments as described above, the example has been described in which the information processing apparatus 100 determines a state of the user for each of the frames. However, the information processing apparatus 100 need not always determine states of all of the frames, but may perform smoothing on several frames and determine a state of each of the several frames, for example.

Furthermore, the information processing apparatus 100 may use not only the camera, but also various kinds of sensing information for recognizing the real object. For example, if the real object is the controller CR01, the information processing apparatus 100 may recognize the position of the controller CR01 on the basis of the speed or the acceleration measured by the controller CR01 or information on a magnetic field generated by the controller CR01.

Moreover, of the processes described in each of the embodiments, all or part of a process described as being performed automatically may also be performed manually. Alternatively, all or part of a process described as being performed manually may also be performed automatically by known methods. In addition, the processing procedures, specific names, and information including various kinds of data and parameters illustrated in the above-described document and drawings may be arbitrarily changed unless otherwise specified. For example, various kinds of information described in each of the drawings are not limited to information illustrated in the drawings.

Furthermore, the components illustrated in the drawings are functionally conceptual and do not necessarily have to be physically configured in the manner illustrated in the drawings. In other words, specific forms of distribution and integration of the apparatuses are not limited to those illustrated in the drawings, and all or part of the apparatuses may be functionally or physically distributed or integrated in arbitrary units depending on various loads or use conditions. For example, the recognition unit 31 and the acquisition unit 32 illustrated in FIG. 9 may be integrated with each other.

Moreover, the embodiments and modifications as described above may be arbitrarily combined as long as the processes do not conflict with each other.

Furthermore, the effects described in this specification are merely illustrative or exemplified effects, and are not limitative. That is, other effects may be achieved.

### 5. Hardware Configuration

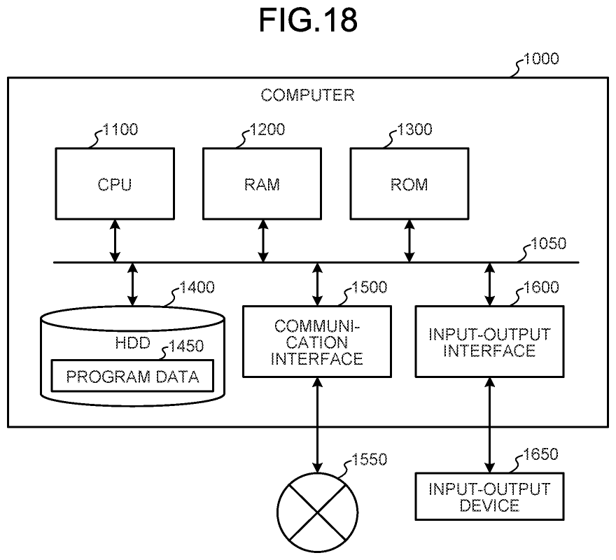

The information equipment, such as the information processing apparatus 100 and the controller CR01, according to each of the embodiments as described above is realized by a computer 1000 having a configuration as illustrated in FIG. 18, for example. The information processing apparatus 100 according to the first embodiment will be described below as an example. FIG. 18 is a hardware configuration diagram illustrating an example of the computer 1000 that implements the functions of the information processing apparatus 100. The computer 1000 includes a CPU 1100, a RAM 1200, a read only memory (ROM) 1300, a hard disk drive (HDD) 1400, a communication interface 1500, and an input-output interface 1600. All of the units of the computer 1000 are connected to one another via a bus 1050.

The CPU 1100 operates on the basis of a program stored in the ROM 1300 or the HDD 1400, and controls each of the units. For example, the CPU 1100 loads the program stored in the ROM 1300 or the HDD 1400 onto the RAM 1200, and performs processes corresponding to various programs.

The ROM 1300 stores therein a boot program, such as basic input output system (BIOS), which is executed by the CPU 1100 at the time of activation of the computer 1000, a program that depends on the hardware of the computer 1000, and the like.

The HDD 1400 is a computer readable recording medium that records therein, in a non-transitory manner, a program to be executed by the CPU 1100, data used by the program, and the like. Specifically, the HDD 1400 is a recording medium that records therein the information processing program according to the present disclosure, which is one example of program data 1450.

The communication interface 1500 is an interface for connecting the computer 1000 to an external network 1550 (for example, the Internet). For example, the CPU 1100 receives data from other devices or transmits data generated by the CPU 1100 to other devices, via the communication interface 1500.

The input-output interface 1600 is an interface for connecting an input-output device 1650 and the computer 1000. For example, the CPU 1100 receives data from an input device, such as a keyboard or a mouse, via the input-output interface 1600. Further, the CPU 1100 transmits data to an output device, such as a display or a speaker, via the input-output interface 1600. Furthermore, the input-output interface 1600 may function as a medium interface that reads a program or the like recorded in a predetermined recording medium (medium). Examples of the medium include an optical recording medium, such as a digital versatile disc (DVD) or a phase change rewritable disk (PD), a magneto optical recording medium, such as a magneto-optical disk (MO), a tape medium, a magnetic recording medium, and a semiconductor memory.

For example, when the computer 1000 functions as the information processing apparatus 100 according to the first embodiment, the CPU 1100 of the computer 1000 executes the information processing program loaded on the RAM 1200 and implements the functions of the recognition unit 31 or the like. Further, the HDD 1400 stores therein the information processing program according to the present disclosure and data that is stored in the storage unit 50. Meanwhile, the CPU 1100 reads the program data 1450 from the HDD 1400 and executes the program data, but, as another example, it may be possible to acquire the program from a different device via the external network 1550.

Additionally, the present technology may also be configured as below.

(1)

An information processing apparatus comprising:

an acquisition unit that acquires a change in a distance between a real object that is operated by a user in a real space and a virtual object that is superimposed in the real space on the display unit, on the basis of a detection result of a sensor that detects a position of the real object; and

an output control unit that displays, on the display unit, a sensory organ object representing a sensory organ of the virtual object for recognizing the real space, and continuously changes a predetermined region of the sensory organ object in accordance with the change in the distance acquired by the acquisition unit.

(2)

The information processing apparatus according to (1), wherein the sensory organ object represents an eyeball of the virtual object.

(3)

The information processing apparatus according to (2), wherein the predetermined region represents a pupil of the virtual object.

(4)

The information processing apparatus according to (3), wherein the output control unit continuously reduces an area of the pupil of the virtual object in accordance with a decrease in the distance acquired by the acquisition unit.

(5)

The information processing apparatus according to (4), wherein

the sensory organ object includes an eyelid of the virtual object, and

the output control unit increases a display area of the eyelid of the virtual object if it is determined that the distance between the eyeball of the virtual object and the real object becomes equal to or smaller than a first threshold on the basis of a detection result of the sensor.

(6)

The information processing apparatus according to any one of (2) to (5), wherein if the distance between the eyeball of the virtual object and the real object becomes equal to or smaller than a second threshold, the output control unit stops control of continuously changing the predetermined region.

(7)

The information processing apparatus according to (6), wherein

the sensory organ object includes an eyelid of the virtual object, and

after stop of the control of continuously changing the predetermined region, a display area of the eyelid of the virtual object is increased on the basis of determination that the distance between the eyeball of the virtual object and the real object is equal to or smaller than a third threshold that is equal to or smaller than the second threshold, on the basis of a detection result of the sensor.

(8)

The information processing apparatus according to any one of (1) to (7), wherein

the sensor has a detection range that exceeds an angle of view of the display unit, and

the output control unit continuously changes the predetermined region on the basis of a change in a distance between a real object that is located outside the angle of view of the display unit and the virtual object.

(9)

The information processing apparatus according to any one of (2) to (8), wherein the output control unit moves the predetermined region such that the predetermined region is approximately perpendicular to a straight line that connects a position of the real object detected by the sensor and a position of the sensory organ object.

(10)

The information processing apparatus according to any one of (1) to (9), wherein

the acquisition unit acquires location information on a head of the user if it is difficult to acquire location information indicating a position of the real object, and

the output control unit changes the predetermined region on the basis of the location information on the head acquired by the acquisition unit.

(11)

The information processing apparatus according to any one of (1) to (10), wherein the acquisition unit acquires a change in a distance between one of a hand of the user and a controller operated by the user, the hand and the controller being sensed by the sensor, and the virtual object.

(12)

The information processing apparatus according to any one of (1) to (11), further comprising:

the display unit that has optical transparency and that is held in a direction of a line of sight of the user.

(13)

An information processing method implemented by a computer, the information processing method comprising:

acquiring a change in a distance between a real object that is operated by a user in a real space and a virtual object that is superimposed in the real space in the display unit, on the basis of a detection result of a sensor that detects a position of the real object;

displaying, on the display unit, a sensory organ object representing a sensory organ of the virtual object for recognizing the real space; and

continuously changing a predetermined region of the sensory organ object in accordance with the acquired change in the distance.

(14)

A non-transitory computer readable recording medium with an information processing program recorded thereon, wherein the information processing program causes a computer to function as:

an acquisition unit that acquires a change in a distance between a real object that is operated by a user in a real space and a virtual object that is superimposed on the real space in the display unit, on the basis of a detection result of a sensor that detects a position of the real object; and

an output control unit that displays, on the display unit, a sensory organ object representing a sensory organ of the virtual object for recognizing the real space, and continuously changes a predetermined region of the sensory organ object in accordance with the change in the distance acquired by the acquisition unit.

### REFERENCE SIGNS LIST

1 information processing system
100 information processing apparatus
20 sensor
30 control unit
31 recognition unit
32 acquisition unit
33 output control unit
50 storage unit
60 output unit
61 display unit
62 acoustic output unit
CR01 controller

1. An information processing apparatus comprising:
an acquisition unit that acquires a change in a distance between a real object that is operated by a user in a real space and a virtual object that is superimposed in the real space on the display unit, on the basis of a detection result of a sensor that detects a position of the real object; and
an output control unit that displays, on the display unit, a sensory organ object representing a sensory organ of the virtual object for recognizing the real space, and continuously changes a predetermined region of the sensory organ object in accordance with the change in the distance acquired by the acquisition unit.

2. The information processing apparatus according to claim 1, wherein the sensory organ object represents an eyeball of the virtual object.

3. The information processing apparatus according to claim 2, wherein the predetermined region represents a pupil of the virtual object.

4. The information processing apparatus according to claim 3, wherein the output control unit continuously reduces an area of the pupil of the virtual object in accordance with a decrease in the distance acquired by the acquisition unit.

5. The information processing apparatus according to claim 4, wherein
the sensory organ object includes an eyelid of the virtual object, and
the output control unit increases a display area of the eyelid of the virtual object if it is determined that the distance between the eyeball of the virtual object and the real object becomes equal to or smaller than a first threshold on the basis of a detection result of the sensor.

6. The information processing apparatus according to claim 2, wherein if the distance between the eyeball of the virtual object and the real object becomes equal to or smaller than a second threshold, the output control unit stops control of continuously changing the predetermined region.

7. The information processing apparatus according to claim 6, wherein
the sensory organ object includes an eyelid of the virtual object, and
after stop of the control of continuously changing the predetermined region, a display area of the eyelid of the virtual object is increased on the basis of determination that the distance between the eyeball of the virtual object and the real object is equal to or smaller than a third threshold that is equal to or smaller than the second threshold, on the basis of a detection result of the sensor.

8. The information processing apparatus according to claim 1, wherein
the sensor has a detection range that exceeds an angle of view of the display unit, and
the output control unit continuously changes the predetermined region on the basis of a change in a distance between a real object that is located outside the angle of view of the display unit and the virtual object.

9. The information processing apparatus according to claim 2, wherein the output control unit moves the predetermined region such that the predetermined region is approximately perpendicular to a straight line that connects a position of the real object detected by the sensor and a position of the sensory organ object.

10. The information processing apparatus according to claim 1, wherein
the acquisition unit acquires location information on a head of the user if it is difficult to acquire location information indicating a position of the real object, and
the output control unit changes the predetermined region on the basis of the location information on the head acquired by the acquisition unit.

11. The information processing apparatus according to claim 1, wherein the acquisition unit acquires a change in a distance between one of a hand of the user and a controller operated by the user, the hand and the controller being sensed by the sensor, and the virtual object.

12. The information processing apparatus according to claim 1, further comprising:
the display unit that has optical transparency and that is held in a direction of a line of sight of the user.

13. An information processing method implemented by a computer, the information processing method comprising:
acquiring a change in a distance between a real object that is operated by a user in a real space and a virtual object that is superimposed in the real space in the display unit, on the basis of a detection result of a sensor that detects a position of the real object;
displaying, on the display unit, a sensory organ object representing a sensory organ of the virtual object for recognizing the real space; and
continuously changing a predetermined region of the sensory organ object in accordance with the acquired change in the distance.

14. A non-transitory computer readable recording medium with an information processing program recorded thereon, wherein the information processing program causes a computer to function as:
an acquisition unit that acquires a change in a distance between a real object that is operated by a user in a real space and a virtual object that is superimposed on the real space in the display unit, on the basis of a detection result of a sensor that detects a position of the real object; and
an output control unit that displays, on the display unit, a sensory organ object representing a sensory organ of the virtual object for recognizing the real space, and continuously changes a predetermined region of the sensory organ object in accordance with the change in the distance acquired by the acquisition unit.
